(19) United States
(12) Patent Application Publication
(10) Pub. No.: US 2025/0392174 A1
(43) Pub. Date: Dec. 25, 2025

(54) LAMINATED CORE AND MANUFACTURING METHOD FOR THE SAME

(71) Applicant: POSCO MOBILITY SOLUTION CORPORATION, Cheonan-si, Chungcheongnam-do (KR)

(72) Inventors: Suk Jo KANG, Asan-si, Chungcheongnam-do (KR); Duk Kyoun WOO, Cheonan-si, Chungcheongnam-do (KR); Jung Gyu CHI, Cheonan-si, Chungcheongnam-do (KR); Jeong Il LEE, Asan-si, Chungcheongnam-do (KR); Dae Yong CHOI, Cheonan-si, Chungcheongnam-do (KR); Young Seok LEE, Cheonan-si, Chungcheongnam-do (KR); Ki Taek NAM, Pyeongtaek-si, Gyeonggi-do (KR); Yeon Woong KIM, Cheonan-si, Chungcheongnam-do (KR); Ji Young OH, Asan-si, Chungcheongnam-do (KR); Jae Hyeon LEE, Cheonan-si, Chungcheongnam-do (KR)

(73) Assignee: POSCO MOBILITY SOLUTION CORPORATION, Cheonan-si, Chungcheongnam-do (KR)

(21) Appl. No.: 18/878,901

(22) PCT Filed: May 26, 2023
(86) PCT No.: PCT/KR2023/007238

§ 371 Date: Dec. 26, 2024

(30) Foreign Application Priority Data
Dec. 30, 2022 (KR) 10-2022-0190397
Mar. 29, 2023 (KR) 10-2023-0041392

(51) Int. Cl. H02K 1/16; B21D 28/26; H02K 15/021

(52) U.S. Cl. CPC H02K 1/16; B21D 28/26; H02K 15/021

(57) ABSTRACT

Disclosed are a laminated core and a method for manufacturing the same. The laminated core includes first layers arranged spaced apart and comprising a plurality of first segments; first protrusions having embossed shape on the first layers and configured to form a plurality of first fixing columns to couple the first layers in succession; and at least one second layers provided between the first layers and comprising a plurality of second segments, wherein a boundary of the first segments is staggered from a boundary of the second segments, the second layers are provided with first holes through which the first fixing columns pass, and the first protrusions are connected in a row by press fitting in a protruding direction to form the first fixing column. The parallelism, perpendicularity, and flatness of the laminated core may be improved, bending of the lamina segments and crushing of protrusions may be remedied, and the number of layers fixed to one protrusion may be changed depending on the protruding height of the protrusion.

### TECHNICAL FIELD

The present invention relates to a laminated core and a method for manufacturing the laminated core, and more particularly to a laminated core including layers bound by embossed protrusions connected to each other in a row by press fitting in a protruding direction and formed by a plurality of lamina pieces and a method for manufacturing the same.

### BACKGROUND ART

In general, an iron core is used in a rotating device such as a motor or a generator, or in an ignition plug. Recently, a core having a structure in which thin plates i.e., laminas having a predetermined shape are stacked and coupled is used and called a laminated core.

Each layer of the laminated core, i.e., each lamina, may be a one-piece, or may be formed by combination of a plurality of lamina pieces or segments.

By disposing a plurality of lamina segments and forming one layer, it is possible to increase the utilization rate of a core material i.e., a metal strip.

As the laminated core manufacturing method that the laminas are laminated/integrated to form the laminated core, a tab fixing method using continuous coupling between interlocking tabs, i.e., embossed protrusions and an adhesion method where the laminas are integrated via adhesive are known.

As an example of the adhesion method coupling the laminas using adhesive, i.e., adhesive laminated core manufacturing technology, methods for manufacturing a laminated core by applying the adhesive to the surface of a metal strip supplied to an apparatus (die) for manufacturing a laminated core and blanking the metal strip are disclosed in Korean Registered Patent No. 10-1566491 and Japanese Patent Publication No. H5-304037, etc.

The laminas are formed by blanking of the metal strip, are stacked in an inner space (lamination hole) of a stacking die in an up and down direction and integrated.

Meanwhile, a lamina of a laminated core manufactured by the tab fixing method has an embossed protrusion (also called as an interlock tab or a caulking protrusion) formed on the lamina, by pressing one side and protruding to the other side, for coupling the laminas.

The tab fixing method, is known in the field of laminated core, and the embossed protrusion formed on the lamina enables coupling between adjacent laminas.

### DISCLOSURE

### Technical Problem

It is an object of the present invention to provide a laminated core including layers formed by a plurality of lamina pieces, i.e., lamina segments, forming a layer fixing structure in which, in order to minimize or prevent the occurrence of a gap at the interface between layers due to interference between interlocking tabs, i.e., embossed protrusions, the interlocking tabs are passing through at least one lamina and continuously coupled and a method for manufacturing the same.

Another object of the present invention is to provide a laminated core having a plurality of fixing columns formed by embossed protrusions continuously connected in a row through a piercing hole and having a structure in which a boundary between the lamina segments is shifted when layers are changed and a method for manufacturing the same.

### Technical Solution

An embodiment of the present invention provides a laminated core including first layers arranged spaced apart and including a plurality of first segments, first protrusions having embossed shape on the first layers and configured to form a plurality of first fixing columns to couple the first layers in succession, and at least one second layers provided between the first layers and comprising a plurality of second segments, wherein the second layers are provided with first holes through which the first fixing columns pass, and the first protrusions are connected in a row by press fitting in a protruding direction to form the first fixing column. A boundary of the first segments may be staggered from a boundary of the second segments. As a result, a plurality of second segments may be fixed to one first segment.

first protrusions formed along a same line, among the first protrusions, are coupled and form the first fixing column, in the way that a convex portion of a trailing protrusion coupled to a concave portion of a leading protrusion by press fitting in the protruding direction.

The laminated core may further include second protrusions having embossed shape on the second layers and configured to form a plurality of second fixing columns to couple the second layers in succession. The first layers may be provided with second holes configured to allow the second fixing columns to pass through.

The first segments and the second segments may be annularly disposed to form the first layer and the second layer. The boundary of the first segments may be formed at a position shifted from the boundary of the second segments in a circumferential direction.

More particularly, the boundary of the first segments may be formed at a position shifted from the boundary of the second segments by ½ of the arc angle of the first segment. As a result, two second segments may overlap one side of the first segment by half.

The first protrusions may include projections formed on each of the first segments and spaced apart from each other by ½ of the arc angle of the first segment in the circumferential direction.

The first holes may include a plurality of holes formed in each of the second segments and spaced apart from each other by ½ of the arc angle of the second segment in the circumferential direction.

The laminated core may further include second protrusions formed on the second layers and configured to form a plurality of second fixing columns coupling the second layers in succession, each of the second protrusions being embossed, wherein the first layers are provided with second holes configured to allow the second fixing columns to pass through.

The second protrusions may include projections formed on each of the second segments and spaced apart from each other by ½ of the arc angle of the second segment in the circumferential direction, and the second holes may include a plurality of holes formed in each of the first segments and spaced apart from each other by ½ of the arc angle of the first segment in the circumferential direction.

The first layer and the second layer may be alternately stacked with at least one layer, a predetermined number of times.

The height of the first protrusion may be greater than the thickness of the second layer. For example, the height of the first protrusion may be N times the thickness of the second layer (N being a natural number of 2 or more).

The laminated core may further include at least one cover layer directly stacked on a first layer located at an end in the protruding direction of the first protrusion, among the first layers, or indirectly stacked on the first layer in the state in which another layer is interposed therebetween, the cover layer being configured to prevent the first protrusion from protruding from the surface of the laminated core.

Another embodiment of the present invention provides a method of manufacturing a laminated core including first layers including first segments having embossed first protrusions thereon, and second layers including second segments and having holes configured to allow the first protrusions to be inserted thereinto.

The method may include stacking the first layer and the second layer on a cover layer forming a bottom surface of the laminated core and having finishing holes to which the first protrusions are fixed by fitting, and forming a lower laminate having a structure where the second layer and the cover layer are fixed under the first layer, and alternately stacking the second layer and the first layer on the lower laminate a predetermined number of times such that a boundary of the first segments and a boundary of the second segments are staggered from each other to form a layer fixing structure with fixing columns formed by the first protrusions coupled in a row by press fitting in succession.

### Advantageous Effects

According to the present invention, the thickness deviation between regions of a laminated core may be remedied, and the parallelism, perpendicularity, and flatness of the laminated core may be improved. In addition, according to the present invention, crushing of an embossed protrusion configured to couple layers, i.e., laminas, of the laminated core and bending of the layers may be remedied, the number of layers fixed to one protrusion may be increased by increasing the height of the protrusion, and separation between the layers may be remedied. Furthermore, according to the present invention, additional process for coupling lamina segments of the same layer is not required, whereby productivity may be improved.

### DESCRIPTION OF DRAWINGS

The present invention can be well appreciated with reference to drawings described below jointly with a detailed description for exemplary embodiments of the present invention to be described below, in which

FIGS. 1A to 1C are views for describing an example of a layer fixing structure applicable to embodiments of a laminated core according to the present invention;

FIGS. 2A to 2C are sectional views schematically showing an example of a fixing column applicable to the present invention;

FIG. 3 is a sectional view showing an example of a layer fixing structure using the fixing column shown in FIG. 2;

FIG. 4 is a view showing another example of the layer fixing structure for the present invention;

FIG. 5 is a view showing yet another example of the layer fixing structure for the present invention;

FIG. 6 is a partial sectional view of lamina segments for the layer fixing structure shown in FIG. 7;

FIG. 7 is a sectional view showing a further example of the layer fixing structure for the present invention;

FIG. 8 is a view showing one embodiment of a laminated core manufacturing apparatus for forming the fixing column shown in FIG. 3;

FIG. 9 is a view illustrating a piercing punch elevation structure (a punch height adjuster) for the apparatus of FIG. 8;

FIG. 10 is a view illustrating a method of stacking lamina segments forming the layer fixing structure shown in FIG. 3;

FIG. 11 is a view illustrating a method of stacking lamina segments forming the layer fixing structure shown in FIG. 5;

FIG. 12 is a perspective view showing a specific embodiment of a laminated core having the layer fixing structure shown in FIG. 3;

FIGS. 13A and 13B are views showing lamina segments for manufacturing the laminated core shown in FIG. 12;

FIGS. 14 and 15 are views showing a process of forming a first layer and a second layer using the lamina segments shown in FIGS. 13A and 13B;

FIG. 16 is a perspective view showing a specific embodiment of a laminated core having the layer fixing structure shown in FIG. 5;

FIGS. 17A to 17C are views showing lamina segments for manufacturing the laminated core shown in FIG. 16; and

FIGS. 18 to 20 are views showing layers formed by the lamina segments shown in FIGS. 17A to 17C.

### BEST MODE

Hereinafter, preferred embodiments of the present invention are described with reference to the accompanying drawings. In describing the embodiments, the same name and the same reference numeral are used with respect to the same element and repetitive description thereto will be omitted. And the descriptions of technologies well known in the art are omitted or minimized.

The terms used herein are used to explain embodiments of the present invention, and do not limit the present invention. For example, terms regarding ordinal numbers, such as “first” and “second,” may be used to distinguish elements from each other, but do not define or limit the number of elements.

And when an element is mentioned as “connected”, “stacked”, or “provided” to other element, although it may be directly connected or stacked or provided, it should be understood that it also includes a relationship with another element therebetween, that is, a relationship of indirect connection.

In this specification, it should be understood that term “include” or “have” described in this specification not exclude a possibility of presence or addition of one or more other features, numbers, steps, operations, components, parts or combinations thereof.

Embodiments of a laminated core according to the present invention are a multilayer structure formed by lamination of laminas L, and more particularly have laminas formed by combination of lamina pieces, i.e., lamina segments.

Embodiments of the present invention have a layer fixing structure in which the embossed protrusions passing through piercing holes are connected in a row by press fitting in a protruding direction, form fixing columns, and couple layers of the laminated core. Among the protrusions forming the fixing column, a convex part of a trailing protrusion is press-fitted into a concave part of a leading protrusion in the protruding direction.

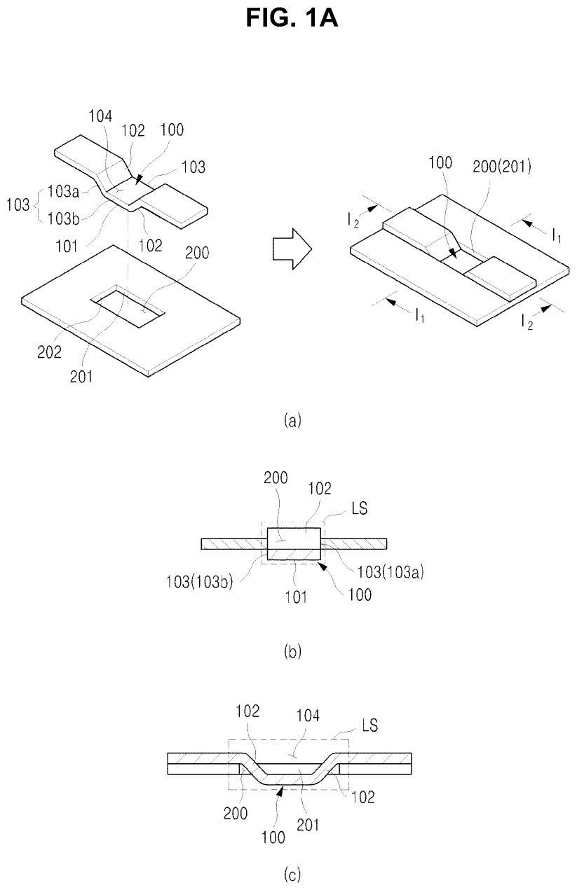

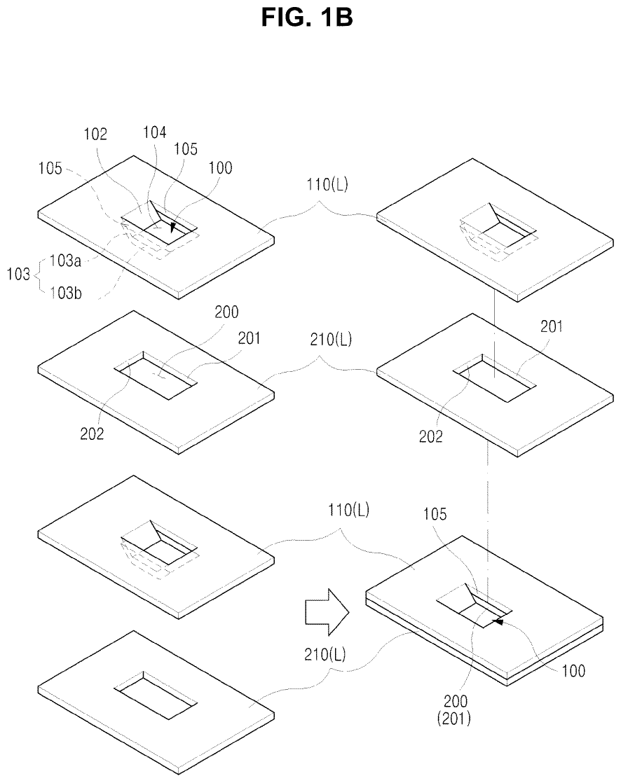

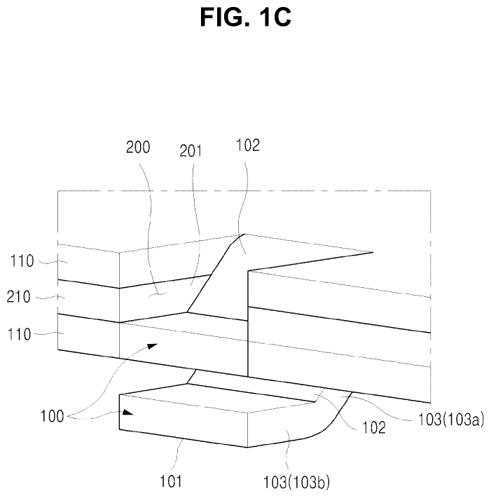

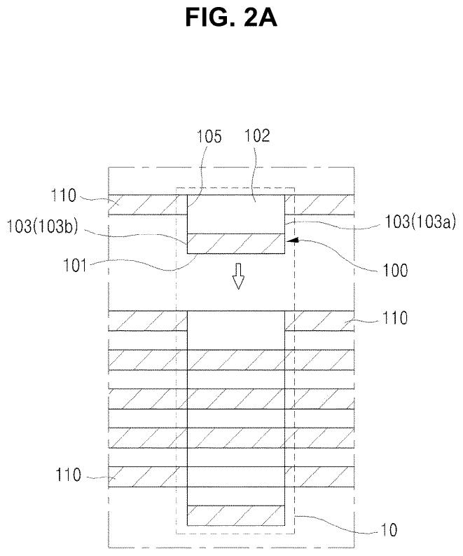

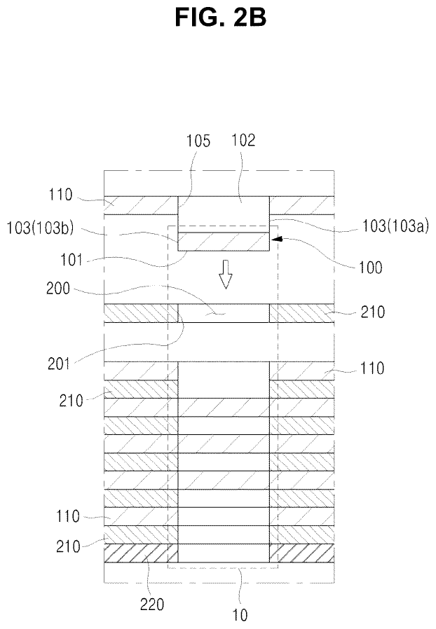

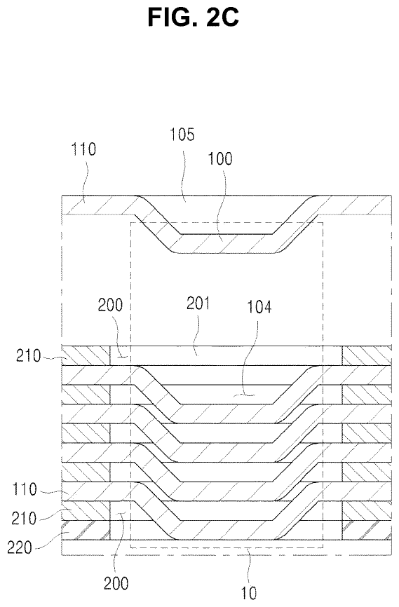

Hereinafter, an example of the fixing column formed by the embossed protrusions will be described with reference to FIGS. 1A to 1C and FIGS. 2A to 2C.

Referring to FIGS. 1A to 1C and FIGS. 2A to 2C, embodiments of the laminated core according to the present invention have a layer fixing structure for fixing laminas 110 and 210 of adjacently stacked layers, by the connection of an embossed protrusion 100 and a piercing hole 200 formed on the same line.

one 110 of the adjacent layers has the protrusion 100, and the other one 210 has the piercing hole 200 passing through the position of the protrusion 100.

That is, the protrusion 100 protrudes from one side (lower side) of the lamina, and the piercing hole 200 is a hole passing through the lamina in the thickness direction (up and down direction). For example, the piercing hole 200 is a through hole formed by piercing process.

The protrusion 100 is inserted into the piercing hole 200 and connects the laminas 110 and 210 of the adjacent layers, and a locking structure LS in (b) and (c) of FIG. 1A is repeated on the same line to form a fixing column 10 that couples layers as illustrated in FIGS. 2A to 2C.

FIG. 2A is a view without a second segment, and FIG. 2B is a sectional view orthogonal to FIG. 2C.

In embodiments of the present invention, an embossed shape of the protrusions 100 pass through the holes 200 and are coupled in a row by press fitting, whereby layers having laminas 110 having the protrusions 100 may be coupled and spaced apart in a lamination direction, and laminas 210 having the holes are fixed between the laminas 110 with the protrusions 100.

The protrusion 100 may have a connection portion 102 configured to connect a tip 101 of the protrusion to the lamina and a fitting surface 103 configured to form side edges of the tip 101 and the connection portion 102 and fitted into the hole 200.

More particularly, the fitting surface 103 includes a first fitting surface 103a forming the edges of the connection portion 102 and a second fitting surface 103b forming the edges of the tip 101. In this embodiment, the protrusion 100 narrows toward the tip 101 and may has a pair of the connection portion 102 with an inclined shape.

The protrusion 100 has an embossed shape having a concave rear surface, and for example, the protrusion 100 may be formed by embossing process pressing a material (metal strip). Accordingly, the protrusion 100 has a convex portion protruding from one surface of the lamina and a concave portion 104 formed in a rear surface of the protrusion 100.

Any lamina having the protrusion 100A may include an attaching surface 105 configured to form an inlet edge of the concave portion 104 and to be attached to the convex part of another protrusion (trailing protrusion) inserted into the concave portion 104 by fitting. By embossing, the attaching surface 105 and the fitting surface 103 may be shear surfaces split to have misaligned shapes.

Next, the piercing hole 200 is a hole into which the protrusion 100 is inserted, and the protrusion 100 may be inserted into the hole 200 by loose fitting or interference fitting.

Specifically, a border of the hole 200 receiving the protrusion 100 has a counter surface 201 to which the protrusion 100 is fitted. The counter surface 201 forms both edges of the hole 200 attached to the attaching surface 105.

In other words, when the protrusion 100 is inserted into the hole 200, the first fitting surface 103a contacts the counter surface 201, and the second fitting surface 103b contacts the concave portion 104 of a leading protrusion, i.e., the fitting surface 105 of the concave portion. A spaced surface 202 configured to prevent interference between the connection portion 102 and the hole 200 is formed on the edge of the hole 200.

When the protrusion 100 is fitted to the hole 200 by fitting, a gap is formed between the connection portion 102 and the space surface 202. The counter surface 201 and the spaced surface 202 may be shear surfaces formed on a metal strip by piercing.

In this embodiment, the hole 200 is a quadrangular hole, wherein two parallel edges of the hole form the counter surface 201 and the rest two edges form the spaced surface 202.

Although the protrusion 100 of the present embodiment is a quadrangular protrusion (quadrangular embossing), the shape of the protrusion is not limited to the shape illustrated herein, various other shapes such as an elliptical/circular shape are possible, and it is obvious that the shape of the hole may be changed in response to the shape of the protrusion. The tip 101 of the protrusion shown in FIG. 1A is flat but is not limited thereto, and other shapes such as a downwardly curved surface or a sharped shape are also possible, but a flat shape is preferred to increase fitting force.

The protrusion 100 may pass through at least one layer of lamina having the hole 200 formed on the same line with the protrusion 100 and may be press-fitted into a concave portion 104 of a leading protrusion located thereunder, and such a locking structure LS may be repeated to form a fixing column 10 that couples a plurality of layers.

A plurality of fixing columns 10 may be formed in the laminated core, and the laminated core may have lamina pieces, i.e., lamina segments disposed in the same layer.

The number of laminas coupled to one protrusion may be varied depending on the protruding height of the protrusion 100. If the height of the protrusion is greater than the thickness of the hole, for example, N times the thickness of the hole (N being a natural number), N laminas with the hole may be successively fixed to one protrusion 100. The height of the protrusion 100 may vary on the depth of embossing, and the value of N is not limited to a natural number.

As an example, when the height of the protrusion 100 is twice the thickness of the hole, the protrusion 100 may pass through one sheet of lamina with the hole 200 and may be fitted to the concave recess 104 of a protrusion formed in the leading lamina, and the hole 200 may prevent interference between the protrusions.

More specifically, on the assumption that, for convenience of description, the protruding direction of the protrusions 100 is a downward direction, an upper one of a pair of protrusions directly connected to each other is an upper protrusion, and a lower one of the pair of protrusions is a lower protrusion, a lower surface of the upper protrusion is not in contact with the concave recess 104 of the lower protrusion, whereby the occurrence of a gap at the interface between adjacent laminated laminas L may be prevented, and the deformation of the protrusion and the surrounding area thereof may be minimized or prevented.

The first fitting surface 103a of the upper protrusion is in contact with the counter surface 201 of the piercing hole, and the second fitting surface 103b of the upper protrusion is in contact with the fitting surface 105 of the lower protrusion. In the above connection structure, the protrusions 100 may pass through at least one lamina and may be successively coupled together in a back-to-back connection to form a fixing column 10, and plural sheets of laminas may be coupled by the fixing column 10.

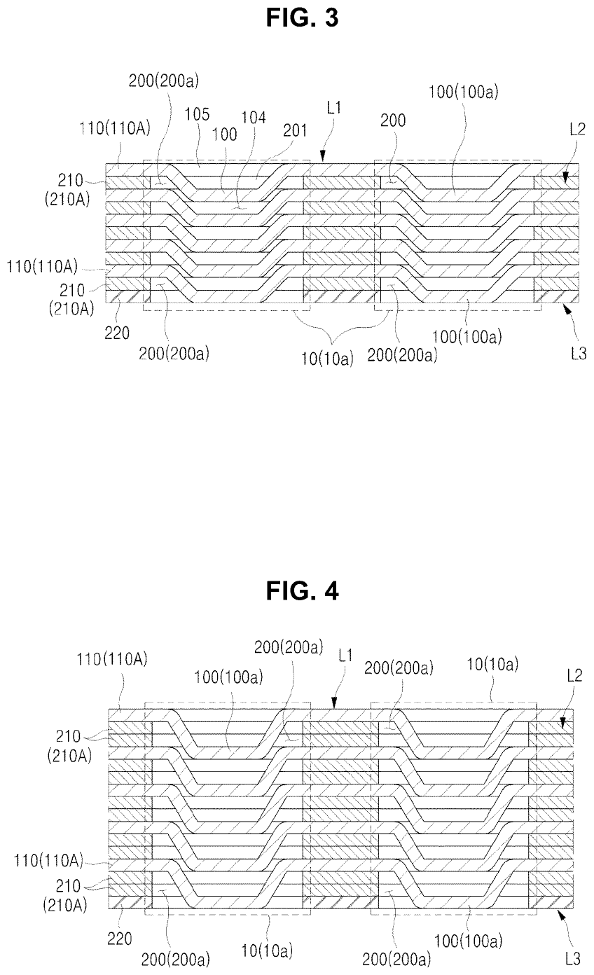

For example, as shown in FIG. 3, a layer L1 (hereinafter referred to as a “first layer”) including laminas 110 with the protrusions 100 and a layer L2 (hereinafter referred to as a “second layer”) including laminas 210 with the holes 200 on the same line as the protrusions 100 may be alternately stacked, and the protrusions 100 form plural lines of fixing columns 10.

That is, according to the fixing column 10 illustrated in FIG. 3, one second layer L2 is provided between the first layers L1, and one second layer L2 and one cover layer L3 are stacked under the final one of the first layers L1 of the protrusion 100.

Each of the laminas 110 and 210 includes a plurality of lamina segments, and for convenience of description, a lamina segment of the first layer L1 is referred to as a first segment 110A, a lamina segment of the second layer L2 is referred to as a second segment 210A, the protrusion 100 of the first layer L1 is referred to as a first protrusion 100a, the hole 200 of the second layer L2 is referred to as a first hole 200a, and the fixing column 10 formed by the first protrusions 100 is referred to as a first column 10a.

The cover layer L3 may be formed by combination of lamina segments 220 (hereinafter referred to as a “third segment”) having the same shape as the second segment 210A, the first protrusion 100a formed on the lowermost one of the first layers is press-fitted into a hole (finishing hole) of the cover layer L3, i.e., a piercing hole of the third segment 220, and the cover layer L3 is a finishing layer that prevents the first protrusion 100a from protruding from the surface (bottom surface) of the laminated core.

As shown in FIG. 3, the first protrusion 100a passes through the second segment 210 having the first hole 200a and is fitted to a concave portion 104 of a rear surface of another protrusion (preceding protrusion) by fitting.

As shown in FIGS. 3 and 4, the protruding height of the first protrusion 100a is greater than the thickness of the second layer L2. More particularly, the height of the first protrusion 100a may be N times the thickness of the second layer (N being a natural number greater than or equal to 2).

If the height of the first protrusion 100 is N times the thickness of the second segment, i.e., the thickness of the piercing hole, for example, when N is a natural number of 2 or more, (N−1) layers of second layers L2 may be provided between the first layers L1. In the embodiment shown in FIG. 3, the protruding height of the first protrusion 100 is twice the thickness of the second layer L2 (N=2).

The N value may exceed 2. For example, the N value may be 3 or more. The first protrusion 100 shown in FIG. 4 has a protruding height equivalent to three times the thickness of the second segment 210 (N=3), two sheets of the second layers L2 may be provided at one side of each first layer L1, and the final one of the second layers L2 formed by the second segment 210A in the protruding direction of the first protrusion 100a overlaps the cover layer L3. Therefore, the number of second layers L2 that can be stacked successively adjacent to one side of the first layer may be varied depending on the height of the embossed protrusion 100 formed on the first layer.

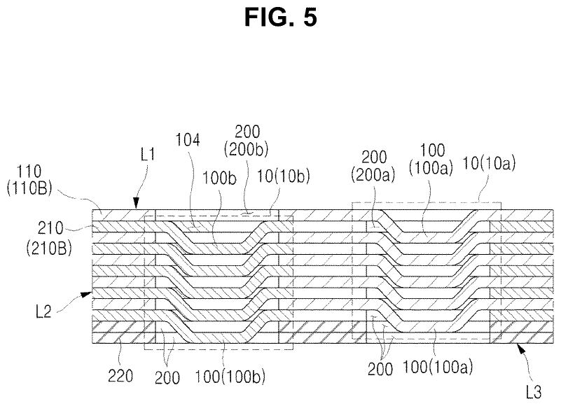

In the embodiments shown in FIGS. 3 and 4, a plurality of the first protrusions 100a is formed on the first segment 110A, a plurality of the holes 200a is formed in the second segment 210A on the same line as the first protrusions 100a such that the first protrusions 100a can be fitted into the holes 200a, the embossed protrusion 100 is formed only on the first segment 110A, and the hole 200 is formed only in the second segment 210A, however, the present invention is not limited thereto. The hole 200 may be formed in the first segment in addition to the protrusion 100, and the protrusion 100 may be formed on the second segment in addition to the hole 200. For example, as shown in FIGS. 5 to 7, lamina segments each having the protrusion 100 and the hole 200 together may form fixing columns for another embodiment of the present invention.

In the present description, for convenience of description, the protrusion of the first layers is referred to as a first protrusion and the fixing column formed by the first protrusion is referred to as a first column, and when an additional embossed protrusion is formed on the second layers to form an additional fixing column with the same function and coupling structure as the first protrusion, the protrusion of the second layer is referred to as a second protrusion, and the fixing column formed by the second protrusion is referred to as a second column.

Even if the protrusion 100 formed on the first layer L1 is called first protrusion, as shown in FIGS. 3 and 4, the designation first protrusion does not presuppose the presence of an additional protrusion on the second layer.

Referring to FIGS. 5 to 7, other embodiments of the present invention include first layers L1 having embossed protrusions 100 and holes 200 and second layers L2 having holes 200 and embossed protrusions 100.

The first protrusions 100a of the first layer L1 form a plurality of first columns 10a having the locking structure LS, and the first holes 200a of the second layer are formed at positions where the plurality of first fixing columns 10a pass.

The second protrusions 100b of the second layer L2 also form a plurality of fixing columns 10, i.e., second columns 10b, having the locking structure LS, and the piercing holes 200, i.e., the second holes 200b, of the first layer are formed at positions where the second columns 10b pass.

That is, the embodiments illustrated in FIGS. 5 to 7 have structures in which the holes 200 are added to the first layer L1 and the protrusions 100 are added to the second layer L2 of the embodiments illustrated in FIGS. 3 and 4, wherein the first holes 200a are formed in the second layer L2 so as to correspond to the first protrusions 100a, and the second holes 200b are formed in the first layer L1 so as to correspond to the second protrusions 100b.

The first layer L1 includes a plurality of first segments 110B provided in the same plane. The second layer L2 includes a plurality of second segments 210B provided in the same plane and is interposed between the first layers L1.

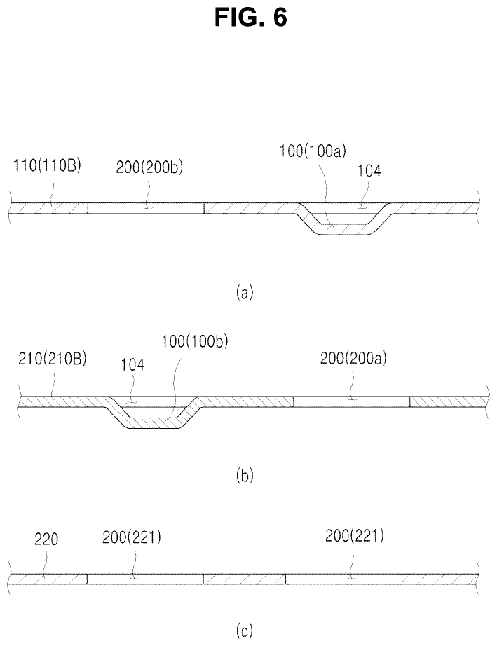

When the thicknesses of the first layer L1 and the second layer L2 are the same, and the height of each of the first protrusion 100a and second protrusion 100b are twice (N=2) the thickness of the second layer L2, a layer fixing structure by the first column 10a and the second column 10b may be formed, as shown in FIG. 5. FIG. 6 is a partial sectional view illustrating an example of the first segment 110B and the second segment 210B forming the layer fixing structure shown in FIG. 5.

That is, the first layer L1 formed by the first segment 110B and the second layer L2 formed by the second segment 210B are alternately disposed, and two cover layers L3 may be disposed successively under the lowermost one of the second layers L2. Also, a layer having the same shape as the first layer L1 may be disposed under the lowermost one of the second layers L2, and two cover layers L3 may be disposed successively thereunder.

A piercing hole 200, more particularly a finishing hole 221, which is formed at the cover layer L3 and into which the protrusion 100 is fitted by press fitting, is formed at the positions of the first column 10a and second column 10b. In other words, holes 221 identical to the first hole 200a and the second hole 200b may be formed in the cover layer L3.

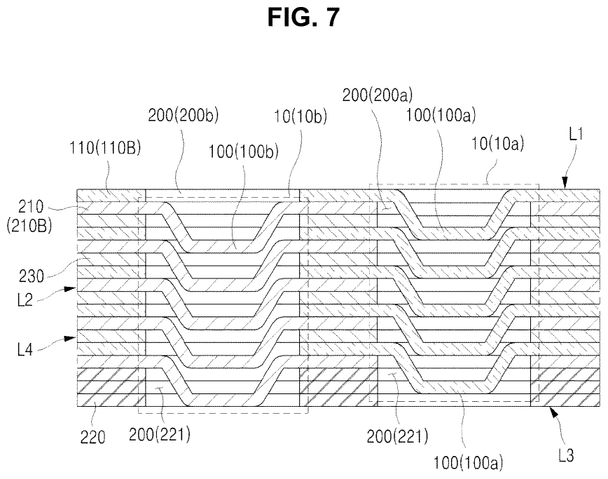

Referring to FIG. 7, corresponding to the protruding height of each of the first protrusion 100a and the second protrusion 100b, an intermediate layer L4 may be interposed between the first layer L1 and the second layer L2.

That is, when the protruding height of each of the first protrusion 100a and the second protrusion 100b exceeds twice (N=2) the thickness of the second layer L3, for example, when the protruding height is three times the thickness, the intermediate layer L4 may be disposed between the first layer L1 and the second layer L2, as shown in FIG. 7.

The intermediate layer L4 may be disposed adjacent to one surface (lower surface) of the first layer L1, or may be adjacent to one surface (lower surface) of the second layer L2. The number of intermediate layers interposed between the first layer L1 and the second layer L2 may be varied depending on the height of each of the first protrusion 100a and the second protrusion 100b.

The intermediate layer L4 has holes formed at the positions of the first column 10a and the second column 10b, like the cover layer L3. The cover layer L3 and the intermediate layer L4 may be formed by lamina segments 220 and 230 having the same shape. As shown in FIG. 7, when the N value is 3, the bottom of the laminated core may be finished by three cover layers L3. The cover layer L3 may prevent the protrusions 100a and 100b from protruding from the surface (bottom surface) of the laminated core and divide laminated cores manufactured sequentially by a progressive die.

In this specification, for convenience of description, the uppermost one of the layers having the protrusions 100 and the holes 200 together and layers formed by lamina segments with the same shape as lamina segments of the uppermost layer may be referred to as a first layer. The layer referred to as the first layer in FIG. 5 may also be referred to as a second layer.

As described above, it is possible to manufacture a laminated core having a structure in which the layers are coupled by the fixing columns 10a and 10b, by alternately stacking the layers with the position of the protrusions 100 and the holes 200 reversed. The number of protrusions 100 and holes 200 formed at the first layer L1 and the second layer L2 may be varied depending on the shape or size of the laminated core, the structure and number of lamina segments forming a single layer, and the like.

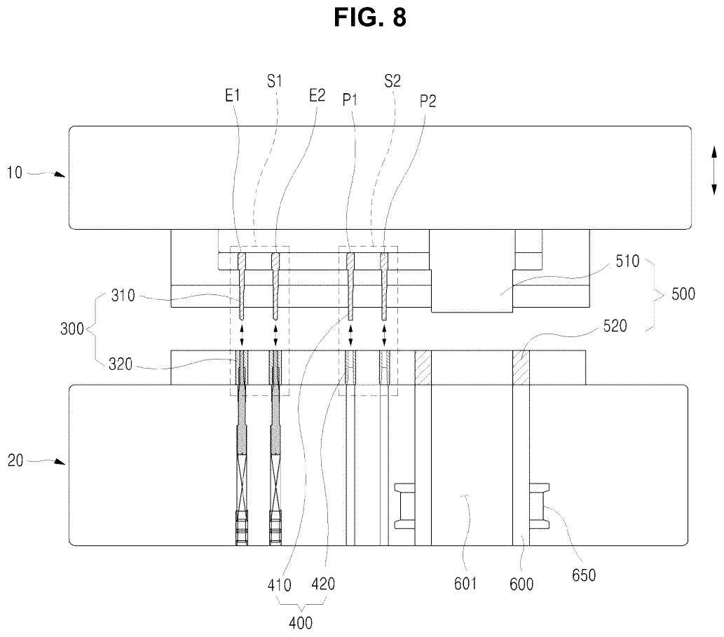

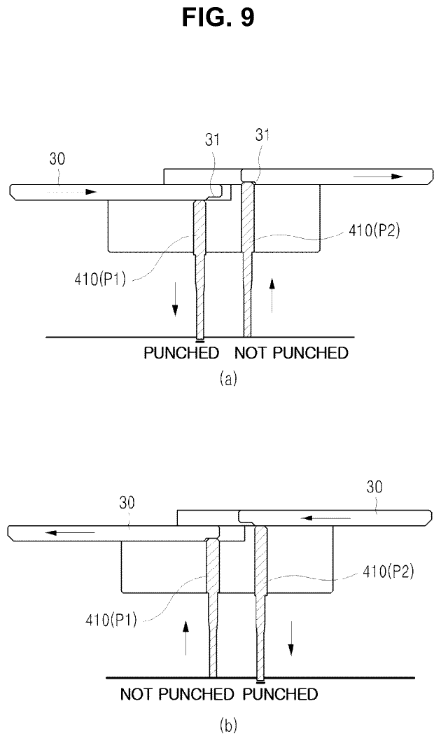

Next, one embodiment of a laminated core manufacturing method and one embodiment of a laminated core manufacturing apparatus will be described with reference to FIGS. 8 and 9.

The laminated core manufacturing method is a method of manufacturing a laminated core including first layers L1 including a plurality of first segments 110 and having embossed protrusions 100 formed thereon and second layers L2 including a plurality of second segments 210 and having formed therein piercing holes 200 into which the protrusions 100 of the first layers are inserted.

The laminated core manufacturing method may include step (a) of stacking the first layer L1 and the second layer L2 on a cover layer L3 having holes 200, i.e., finishing holes, to which the protrusions 100 are fixed by fitting and forming a bottom surface of the laminated core and forming a lower laminate having a structure in which the second layer L2 and cover layer L3 are fixed under the first layer L1 by the protrusion 100, and step (b) of alternately stacking the second layers L2 and the first layers L1 on the lower laminate a predetermined number of times such that a boundary of the first segments and a boundary of the second segments are staggered from each other to form a layer fixing structure with a plurality of fixing columns 10 coupled in a row by press fitting of the protrusions 100.

The step (a) may include step (a1) of blanking a metal strip that is intermittently transferred to form the cover layer L3 in an inner space (lamination space) of a stacking die, step (a2) of blanking the metal strip to form at least one second layer L2 on the cover layer, and step (a3) of blanking the metal strip to form the first layer L1 on an upper surface of the second layer L2.

When manufacturing the laminated core having the layer fixing structure shown in FIG. 3 or 4, the step (a1) is a step of blanking the area of a metal strip in which a finishing hole with same shape as the piercing hole 200 is formed to form the cover layer L3 in the inner space of the stacking die.

The Step (a2) is a step of blanking the area of the metal strip in which the piercing hole 200 is formed to form at least one second layer L2 on the cover layer.

The Step (a3) is a step of blanking the area of the metal strip in which the protrusions 100 are formed to form the first layer L1 on the upper surface of the second layer L2.

In order to form the first layer L1, lamina segments of the same shape having the protrusions 100, i.e., first segments 110, are sequentially introduced into the stacking die and are disposed in the same plane by movement of the stacking die, i.e., by index rotation, and lamina segments of the same shape having the piercing holes 200, i.e., second segments 210, form the second layer L2 in the stacking die.

The laminated core manufacturing method may be performed by various laminated core manufacturing apparatuses. The apparatus for various embodiments of the laminated core is a progressive die, which sequentially manufactures laminated cores having fixing columns according to embodiments of the present invention by machining a metal strip intermittently transferred by a predetermined distance (pitch) per stroke of a press.

The apparatus includes an embossing unit 300 configured to press a metal strip to form the embossed protrusion 100 on the metal strip, a piercing unit 400 configured to form the hole 200 in the metal strip, and a blanking unit 500 configured to blank the metal strip.

The piercing unit 400 may be provided upstream or downstream of the embossing unit or in the same area as the embossing unit in a transfer direction of the metal strip, and forms the piercing hole 200 in the metal strip. The blanking unit 500 blanks the metal strip to form the first segment and the second segment, and is provided downstream of the embossing unit 300 and the piercing unit 400.

The embossing unit 300 includes an elevatable embossing pin (310) and an embossing die (320) facing the embossing pin (310) and configured to support the metal strip. The piercing portion 400 may include an elevatable piercing punch 410 and a piercing die 420 facing the piercing punch and configured to support the metal strip.

The blanking unit 500 may include an elevatable blanking punch 510 and a blanking die 520 facing the blanking punch, and a stacking die 600 having a space for the laminas L is provided under the blanking die 520. The stacking die 600 may have a rotatable structure, i.e., a structure in which index rotation can be performed.

As described above, the stacking die 600 is rotatably provided in a lower die 20, and the stacking die 600 is provided with a rotation mechanism 650. Examples of the rotating mechanism may be a pulley or ring gear to which a belt for power transmission of a motor is connected or other device capable of indexing. The rotatable stacking die is also called a rotating die, and since the rotating die is known in the art related to the laminated core manufacturing apparatus, a further description of the rotating die will be omitted.

When the apparatus is a progressive die, the embossing pin 310, the piercing punch 410, and the blanking punch 510 may be provided at an elevatable upper die 10, and may be elevated together with the upper die 10. The embossing die 320, the piercing die 420, the blanking die 520, and the stacking die 600 are provided at a lower die 20 facing the upper die 10.

Referring to FIG. 8, one embodiment of the laminated core manufacturing apparatus includes a processing stage in which the area to be blanked is machined, so as to sequentially manufacture lamina segments.

In the present embodiment, the processing stage includes a first stage S1 and a second stage S2, wherein the embossing unit 300 is provided at the first stage S1, and the piercing unit 400 is provided at the second stage S2.

And the embossing unit 300 may be provided upstream of the piercing unit 400 in the transfer direction of the metal strip, but may be provided downstream of the piercing unit 400 since forming time of the protrusions and the holes may be adjusted by an elevating device such as a slide bar 30 mentioned later.

In order to implement a laminated core manufacturing apparatus capable of forming only a plurality of protrusions 100 on a single lamina segment, or forming both protrusions and holes at a single lamina segment, the first stage S1 may be provided with a plurality of embossing pins 310, and the second stage S2 may be provided with a plurality of piercing punches 410.

More specifically describing an example of manufacturing the laminated core having the layer fixing structure illustrated in FIG. 3, the embossing pins 310 of the first stage S1 may simultaneously press the area to be blanked on the first stage S1 when the metal strip moves by two pitches, i.e., once whenever the upper die is elevated twice (once every two cycles), to form the protrusions 100. The area to be blanked refers to the expected site that is punched by the blanking punch to form one lamina segment.

The second stage S2 is provided with piercing punches 410 to simultaneously form a plurality of holes 200 on the second stage once every two-pitch transfer of the metal strip.

The embossing pins 310 and piercing punches 410 are height-adjustably provided at the upper die 10 such that the height of the embossing pins and piercing punches can be adjusted in the upper die 10. For example, the embossing pins 310 and piercing punches 410 may be connected to the elevating device such that the height of the embossing pins and piercing punches relative to the upper die can be adjusted.

More particularly, as shown in FIG. 9, an elevating device having a slide bar 30 or a slide plate for adjusting the height of the piercing punch 410 may be provided at the upper die.

The slide bar 30 is linearly movably provided at the upper die 10, and a stepped portion 31 is formed at the slide bar 30. As shown in FIG. 9, when an upper end of the piercing punch 410 is pressed downward by the slide bar 30, whereby the piercing punch 410 is located at a lower limit, the metal strip may be punched when the upper die 10 is moved downward.

When the slide bar 30 is moved and the stepped portion 31 of the slide bar is located above the piercing punch 410, pressing contact between the piercing punch 410 and the metal strip is prevented even if the upper die 10 is moved downward.

The slide bar 30 may be moved linearly by a linear actuator, such as a reciprocating motion device or a cylinder, and the upper die 10 may be provided with a stripper.

Referring to FIG. 9, when both piercing punches P1 and P2 are pressed down by the slide bar 30, the metal strip is punched in the second stage S2 when the upper die 10 is moved downward.

Examples of the elevating device are not limited to the above-described structure (slide cam), and may vary. For example, a rotatable cam for changing the height of the piercing punch while rotating in contact with the upper end of the piercing punch may be employed as the elevating device.

In the progressive type laminated core manufacturing apparatus, the elevating device to retract (upwardly move) the punch for a non-punching process, i.e., an idle process, is known in this art, and therefore a further description of the elevating device will be omitted. An elevating device for height adjustment, i.e., an elevating device having the slide bar 30, may also be applied to the embossing pin 310 such that the timing of embossing by the embossing pin can be adjusted.

According to one embodiment of the laminated core manufacturing apparatus, once for every two-pitch movement of the metal strip, the embossing pins E1 and E2 and the piercing punches P1 and P2 at the lower limit are simultaneously form the protrusions 100 and holes 200 in the first stage S1 and the second stage S2, a predetermined number of times. When the lamina segments for the cover layer are to be formed, the embossing pins E1 and E2 are retracted upward and located at the upper limit, and only the piercing punches P1 and P2 may punch the metal strip at the lower limit to form a finishing hole in the cover layer L3.

In contrast to the example shown in FIG. 8, the embossing pin 310 and the piercing punch 420 may be provided in both the first stage S1 and the second stage S2, and height of each of the embossing pin and the piercing punch can be adjusted.

For example, the layer fixing structure illustrated in FIG. 3 may be formed by exchanging the second one E2 of the embossing pins 310 of the first stage S1 and the second one P2 of the piercing punches 410 of the second stage S2 shown in FIG. 8 and individually adjusting the height of each of the embossing pins and the piercing punches using the elevating device.

The apparatus of FIG. 8 may be used to manufacture a laminated core having the layer fixing structure shown in FIG. 5.

More specifically, whenever the metal strip moves by one pitch, the heights of the embossing pins E1 and E2 on the first stage are alternately adjusted, and the heights of the piercing punches P1 and P2 on the second stage are alternately adjusted.

For example, when both the first embossing pin E1 of the first stage and the first piercing punch P1 of the second stage are located at the lower limit position, the second embossing pin E2 of the first stage and the second piercing punch P2 of the second stage are located at the upper limit.

And then, when the metal strip is moved by 1 pitch, both the first embossing pin E1 of the first stage and the first piercing punch P1 of the second stage are located at the upper limit, and the second embossing pin E2 of the first stage and the second piercing punch P2 of the second stage are located at the lower limit, whereby it is possible to form the layer fixing structure illustrated in FIG. 5. When both the piercing punches of the second stage are located at the lower limit, the finishing hole of the cover layer L3 may be formed.

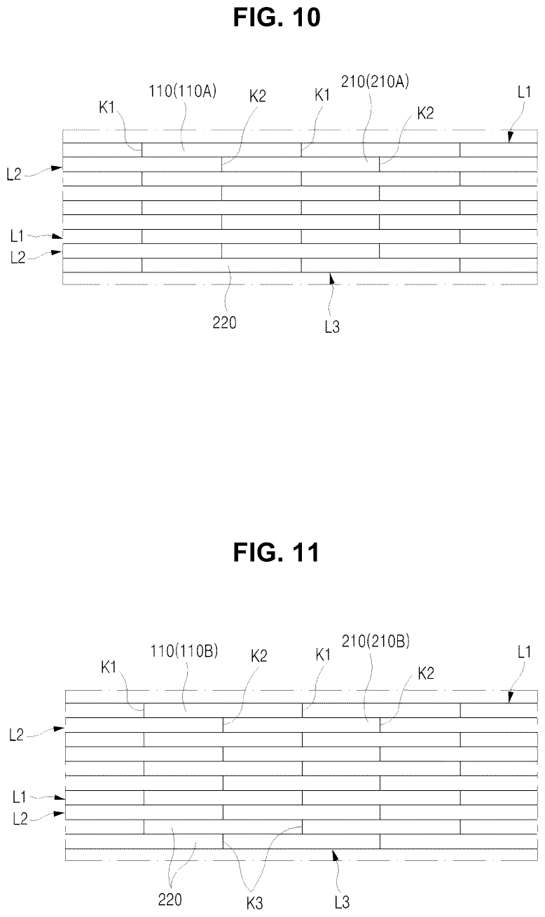

Next, examples of the laminated structure in which a boundary of the lamina segments is shifted when the layers are changed, i.e., the laminated structure in which the first segment and the second segment are staggered from each other, will be described with reference to FIGS. 10 and 11.

Referring to FIG. 10, the second layer L2 is disposed between the first layers L1. That is, the first layers L1 are divided by the second layers L2, and the second layers L2 are divided by the first layers L1. The first layer L1 includes a plurality of first segments 110A, and the second layer L2 includes a plurality of second segments 210A.

A plurality of embossed protrusions 100, i.e., first protrusions shown in FIG. 3 are formed on the first layer L1, to form the plurality of fixing columns 10, i.e., the first columns 10a. More specifically, a plurality of first protrusions 100a are formed on each of the first segments 110A.

And the holes 200 through which the first fixing columns 10a pass, i.e., the first holes 200a shown in FIG. 3, are formed at the second layer L2. Particularly, the plurality of the first holes 200a is formed at each of the second segments 210A.

A boundary K1 (hereinafter referred to as a “first boundary”) of the first segments formed at the first layer may be staggered from a boundary K2 (hereinafter referred to as a “second boundary”) of the second segments formed at the second layer.

In other words, the first boundary K1 and the second boundary may be formed so as to be offset from each other, and one first segment 110A may partially overlap two second segments 210A adjacent to each other in the same plane. That is, a portion of the first segment 110A may overlap one of the two adjacent second segments 210A in the same plane, the rest of the first segment 110A may overlap the other of the second segments, and a relatively large portion of the first segment 110A may overlap with any one of the two adjacent second segments 210A.

At least one first protrusion 100a may be formed on each of a first portion and a second portion of the first segment 110A. Consequently, the two adjacent second segments 210A may be coupled to the first portion and the second portion of the first segment 110A by the first protrusions 100a.

If the first boundary K1 is formed on the center of the second segment 210A, two second segments 210A may overlap one first segment 110A by half. The bottom of the laminated core may be finished by the cover layer L3.

Next, an example of a laminated core having a laminated structure formed by a first layer L1 with first protrusions 100a and second holes 200b and a second layer L2 with first holes 200a and second protrusions 100b, as shown in FIG. 5, will be described with reference to FIG. 11.

The first layers L1 are disposed spaced apart from each other, and the second layer L2 is disposed between the first layers L1. In FIG. 11, the first layers L1 are divided by the second layers L2, and the second layers L2 are divided by the first layers L1.

The first layer L1 includes a plurality of first segments 110B, wherein the first segment 110B is provided with at least one first protrusion 100a and at least one second hole 200b, like the example of FIG. 5. The second layer L2 includes a plurality of second segments 210B, wherein the second segment 210B is also provided with at least one first hole 200a and at least one second protrusion 100b.

The first columns formed by the first protrusions 100a pass through the first holes 200a of the second layer, as shown in FIG. 5. The second holes 200b are provided along the second columns formed by the second protrusions 100b, as shown in FIG. 5.

As shown in FIG. 11, the boundary K1 (first boundary) of the first segments is staggered from the boundary K2 (second boundary) of the second segments. When the first boundary K1 is located on the middle of the second segment 210B, two second segments 210B may overlap one first segment 110B by half.

The first hole 200a and the second protrusion 100b may be formed at a first portion of the second segment 210B, and the first hole 200a and the second protrusion 100b may also be formed at a second portion of the second segment 210B.

Accordingly, one of the two adjacent second segments 210B may be coupled to the first portion of the first segment 110B, and the other of the second segments may be coupled to the second portion of the first segment 110B.

One side (bottom) of the laminated core having the layer fixing structure may be finished by the third lamina segments 220 forming the cover layer L3, and a boundary K3 of the third lamina segments 220 may be formed at a position divergent from a boundary of segments of a layer immediately thereon.

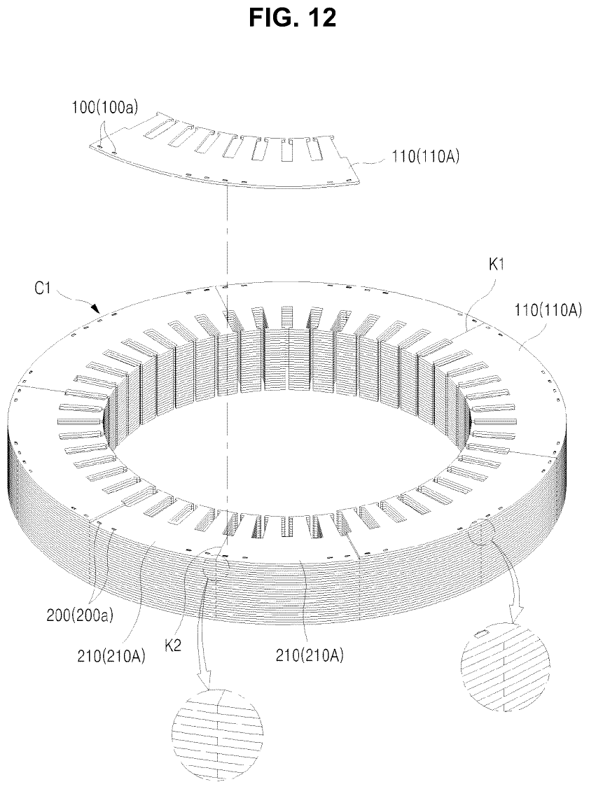

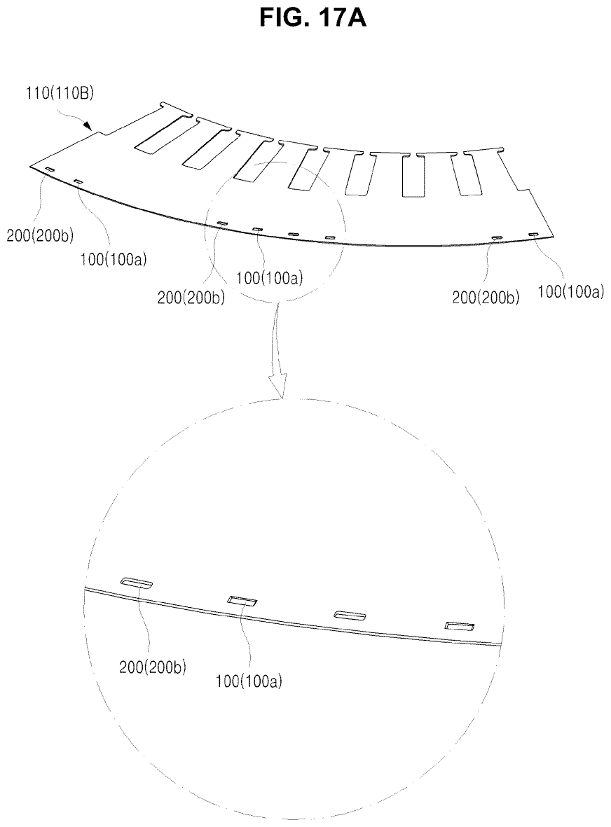

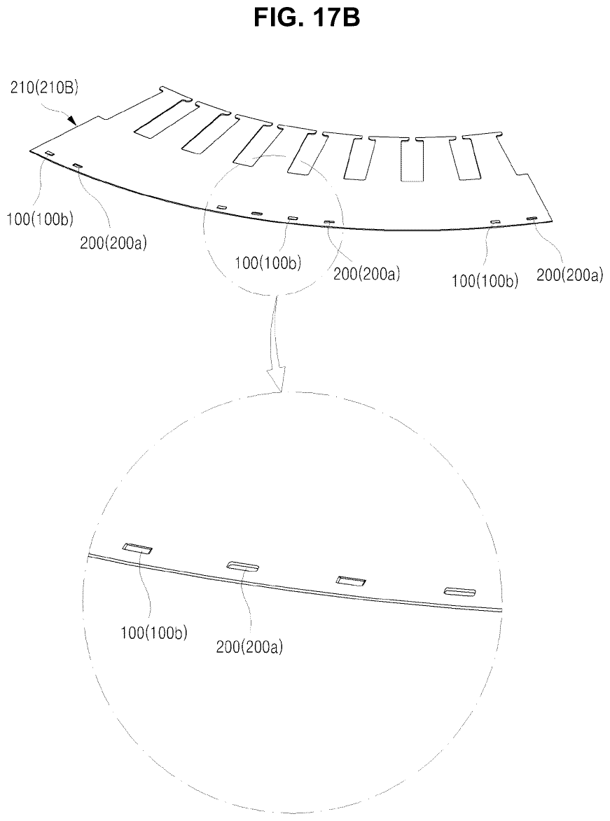

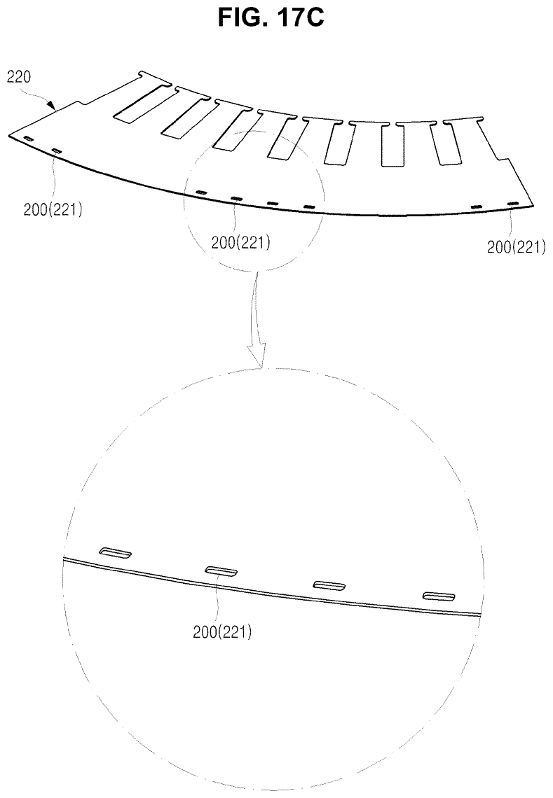

The first segments 110 and the second segments 210 may be disposed annularly to form the first layer L1 and the second layer L2, thereby resulting in a laminated core having an axially hollow center, as shown in FIGS. 12 and 17.

According to FIGS. 10 and 11, the first boundary K1 is formed on the middle of the second segment 210, and two second segments 210 overlap one first segment 110 by half. However, as described above, the first boundary K1 may be formed so as to be biased to one side of the second segment 210A.

If the first boundary K1 is located so as to be biased to one side of the second segment 210A from the middle of the second segment, the first segment 110 is biased to one side at the boundary K2 of the two adjacent second segments 210A, and a relatively large portion of the first segment overlaps one of the two adjacent second segments 210A.

Referring to FIGS. 12 to 15, the first segments 110A having the first protrusions 100a are disposed annularly and form the first layers L1 at a predetermined interval, as a laminated core C1 illustrated in FIG. 12. As described above, the first protrusions 100a disposed in a row along the same line form a first column 10a, as shown in FIG. 3, and in the present embodiment, the first protrusions 100a form a plurality of first columns 10a.

The second segments 210A having the first holes 200a are disposed annularly to form the second layers L2. The first column passes through the first holes 200a.

For manufacturing the laminated core C1 shown in FIG. 12, a first layer L1 without holes having embossed protrusions and a second layer L2 without embossed protrusions having holes 200 are alternately and repeatedly disposed.

The first boundary K1 is shifted from the second boundary K2 in a circumferential direction.

For example, the first boundary K1 may be rotationally shifted from the second boundary K2 by ½ of the arc angle of the first segment 110A. Consequently, two second segments 210A overlap one first segment 110A by half.

As a specific example, when the arc angle of the first segment 110A is 60°, the first segments 110A stacked on the second layer L2 are provided at a position shifted from the second boundary K2 by 30°.

A plurality of first protrusions 100a may be formed on the first segment 110A while being spaced apart from each other by ½ of the arc angle of the first segment 110A in the circumferential direction. Consequently, two adjacent second segments 210A may overlap and may be fixed to one first segment 110A by half.

The first holes 200a may also be formed at each of the second segments 210A while being spaced apart from each other by ½ of the arc angle of the second segment 210A in the circumferential direction. For example, at least one pair of first holes 200a spaced apart from each other by 30° may be formed at the second segment 210A.

In the laminated core C1 according to the present embodiment, the first segment 110A and the second segment 210A have the same outline. when the first segment 110A and the second segment 210A completely overlap each other, the position of the first protrusions 100a and the position of the first holes 200a are the same.

According to the example shown in FIG. 12, the arc angle of the first segment 110A and the second segment 210A is 60°, and the first layer L1 is formed by six first segments 110A, and the second layer L2 is also formed by six second segments 210A.

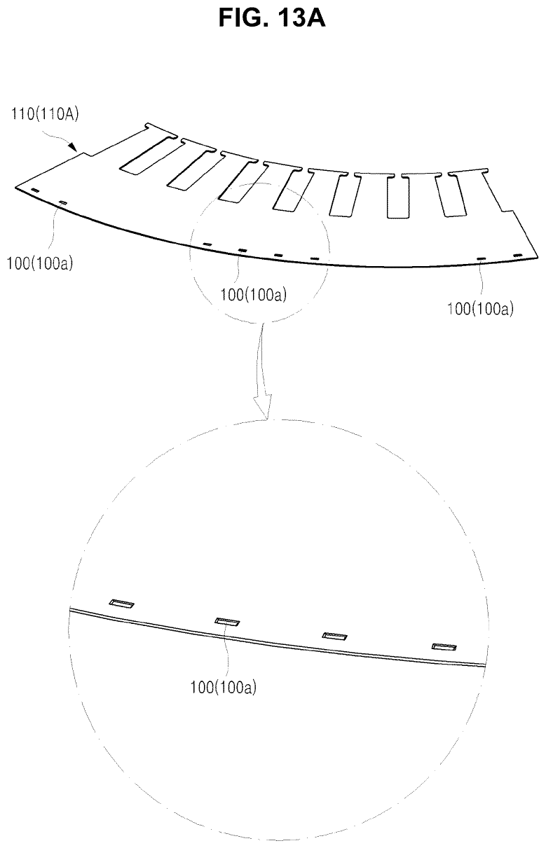

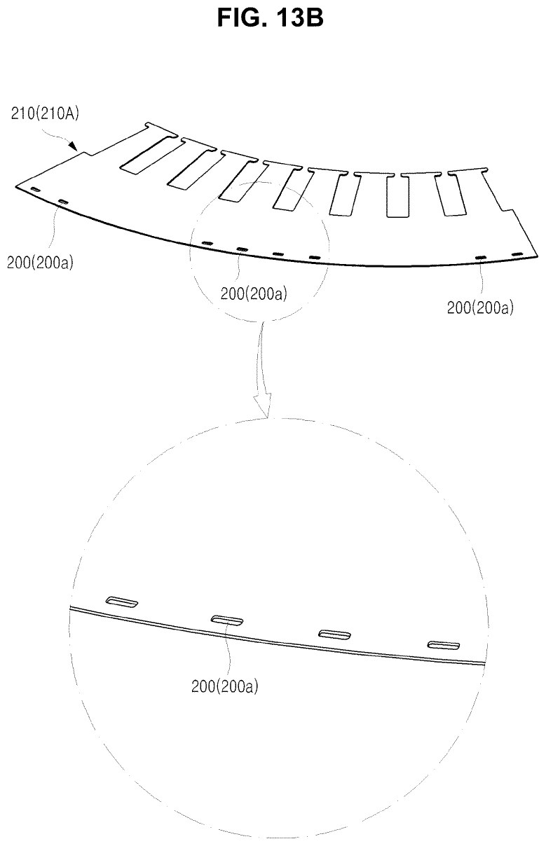

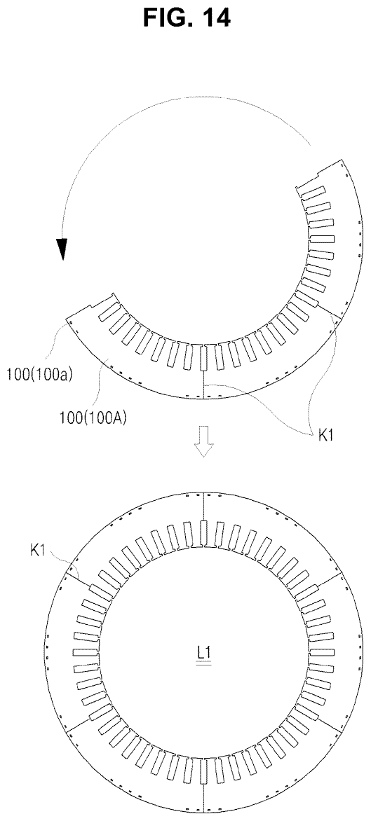

The first segment 110A has a plurality of first protrusions 100a formed at 30° intervals, and one first segment 110A may be provided with four pairs of first protrusions 100a, as illustrated in FIG. 13A.

The second segment 210A has a plurality of first holes 200a formed at the same positions as the first protrusions 100a at 30° intervals, and the second segment 210A may be provided with four pairs of first holes 200a, as illustrated in FIG. 13B.

The rotational shift angle is not limited thereto, and for example, the first boundary K1 may be rotationally shifted from the second boundary portion by a different angle, such as ⅓ or ⅔ of the arc angle of the first segment 110A, in which case the first boundary K1 may be located in a region that is biased from the middle of the second segment 210A.

In order to form the lamina segments shown in FIGS. 13A and 13B, piercing holes 200 may be formed by piercing punches on a piercing stage (stage S2 in FIG. 8), and embossed protrusions 100 may be formed by embossing pins on an embossing stage (stage S1).

The number of piercing punches equal to the number of piercing holes formed in the second segment 210A is provided at the piercing stage such that the height of each of the piercing punches can be adjusted (controlled) by the elevating device, and the number of embossing pins equal to the number of protrusions formed in the first segment 110A is provided at the embossing stage such that the height of each of the embossing pins can be adjusted by the elevating device.

In a blanking stage, the metal strip 1 is blanked, and six first segments 110A sequentially formed by blanking are introduced into the stacking die one after another to form one first layer L1. Six second segments 210A sequentially formed by blanking form one second layer L2 in the stacking die.

Since blanking is carried out in same place, the stacking die is rotated by a predetermined angle per one blanking to form one layer. For example, when each layer is constituted by six lamina segments with the same size, the stacking die rotates by 60° (index rotation), synchronously with the blanking cycle.

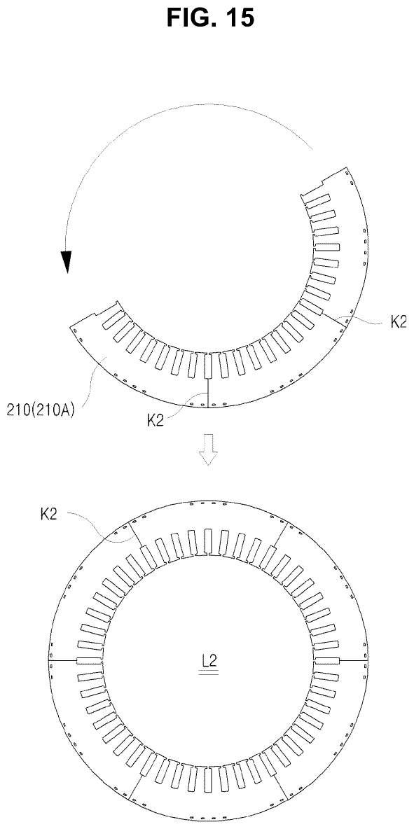

When the second layer L2 is completed in the stacking die such that the first boundary K1 and the second boundary K2 are staggered from each other, the stacking die is rotated (shift rotation) by a preset angle less than the arc angle of the lamina segment, e.g., 30° as shown in the lower image of FIG. 15, and then the first segments are annually disposed (formation of the first layer), whereby the first layer L1 is formed on the second layer L2.

A cover layer formed by lamina segments (third lamina segments) identical to the second segments 210A is provided at the bottom of the laminated core C1 shown in FIG. 12. And one second layer L2 is stacked on the cover layer.

The stacking die is rotated before the second layer is formed on the third layer, whereby a boundary of the third lamina segments formed at the third layer may be staggered from the second boundary K2 formed at the second layer.

According to the present embodiment, by rotation shift of the stacking die, the boundary of the lamina segments may be shifted to various predetermined angles whenever the layer of the laminated core is changed.

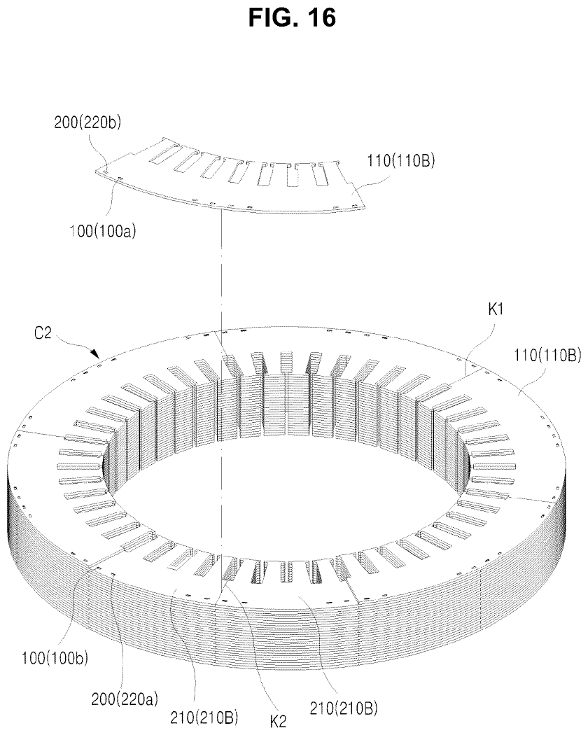

Next, referring to FIGS. 16 to 20, a laminated core C2 illustrated in FIG. 16, includes first layers L1 having both embossed protrusions 100 and piercing holes 200 and disposed spaced apart from each other, and second layers L2 divided by first layers L1 and the disposed between the first layers.

In this embodiment, each of the first layers L1 and the second layers L2 is provided with embossed protrusions 100 and piercing holes 200. For convenience of description, the protrusions of the first layer L1 is called a first protrusion 100a, the protrusion of the second layer L2 is called a second protrusion 100b, the piercing hole of the second layer L2 and the piercing hole of the first layer L1 are referred to as a first hole 200a and a second hole 200b.

Fixing columns configured to bind the layers are formed by the first protrusions 100a and the second protrusions 100b, wherein the fixing column formed by the first protrusions 100a is referred to as a first column, and the fixing column formed by the second protrusions 100b is referred to as a second column. That is, the layer fixing structure shown in FIG. 5 may be applied to the laminated core shown in FIG. 16.

The laminated core shown in FIG. 16 has a laminated structure in which the first layer L1 and the second layer L2 in which the positions of the protrusions and the piercing holes are opposite each other are alternately disposed.

The first layer L1 is formed by first segments 110B that are disposed annularly, and the first segment 110B has the first protrusion 100a and the second hole 200b.

The second layer L2 is formed by second segments 210B that are disposed annularly, and the second segment 210B has the first hole 200a and the second protrusion 100b.

The first boundary K1 and the second boundary K2 are staggered from each other. Since the method of forming the first boundary K1 and the second boundary K2 at staggered positions (rotational shift) is described above, a repetitive description thereof will be omitted.

The first protrusions 100a are formed on the first segment 110B while being spaced apart from each other by the angle of rotational shift, e.g., ½ of the arc angle of the first segment 110B, in the circumferential direction. In addition, the second holes 200b are formed in the first segment 110B while being spaced apart from each other by the angle of rotational shift in the circumferential direction.

The first holes 200a and the second protrusions 100b are formed at the second segment 210B while being spaced apart from each other by the angle of rotational shift in the circumferential direction.

As shown in FIGS. 17A to 17C, the first segment 110B, the second segment 210B, and a third lamina segment 220 for a cover layer have the same outline.

when the first segment 110B, the second segment 210B, and the third lamina segment 220 completely overlap, the positions of the first protrusions 100a and the first holes 200a are the same, the positions of the second protrusions 100b and the second holes 200b are the same, and the third lamina segment 220 has a finishing hole 221 formed on the positions of the first protrusions 100a and second protrusions 100b.

The third lamina segment 220 for the cover layer of the laminated core C2 shown in FIG. 16 has the same structure as the second segment 210A for the laminated core C1 shown in FIG. 12.

The manufacturing process of the laminated core shown in FIG. 12 may be equally applied to the process of forming the first layer L1, the second layer L2, and the cover layer L3, rotation shifting the stacking die when the layers are changed and index-rotating of the stacking die by a predetermined angle, therefore a repetitive description thereof will be omitted.

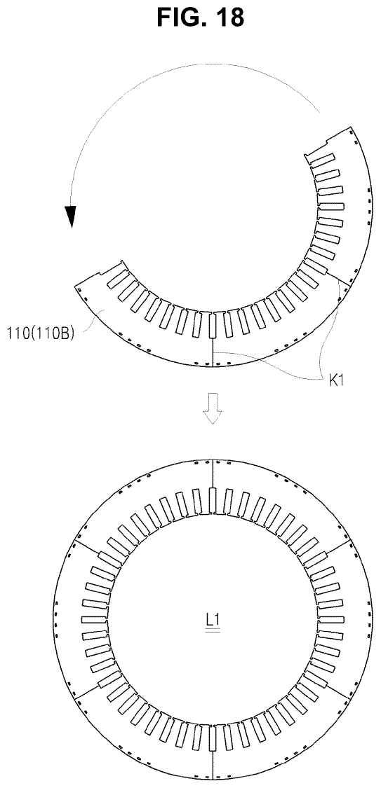

FIGS. 18 to 20 show the first layer L1, the second layer L2, and the cover layer L3 formed by the first segment 110B, the second segment 210B, and the third lamina segment 220 shown in FIGS. 17A to 17C.

In order to form the first protrusion 100a, the second protrusion 100b, the first hole 200a, the second hole 200b, and the finishing hole 221, the piercing position and timing and the embossing position and timing may be adjusted by controlling the height of the piercing punch and the embossing pin in the piercing stage and the embossing stage. For example, when the height of the embossing pins and the piercing punches is selectively adjusted (controlled) by the elevating device illustrated in FIG. 9, the piercing position and the embossing position on the piercing stage and the embossing stage may be changed.

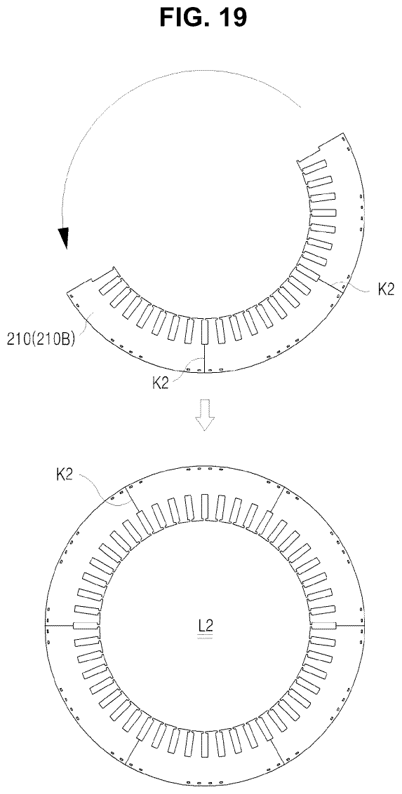

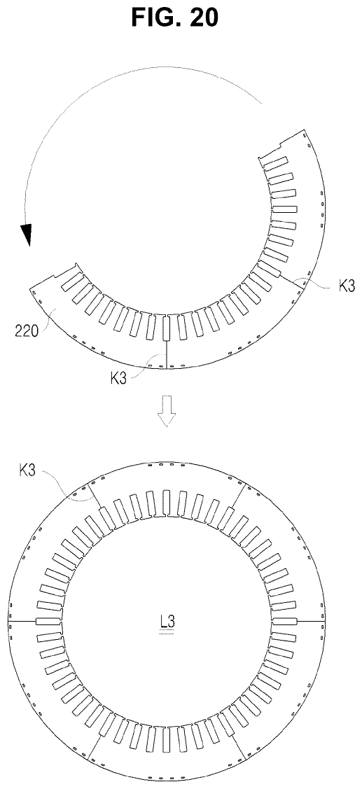

Two cover layers L3, each of which is formed by the third lamina segments 220, are successively provided at the bottom of the laminated core shown in FIG. 16, and the first layer L1 shown in FIG. 18 or the second layer L2 shown in FIG. 19 may be contiguously stacked thereon. When two cover layers L3 are successively stacked, a segment boundary on the upper cover layer and a segment boundary on the lower cover layer may be staggered from each other. The lower image of FIG. 19 and the lower image of FIG. 20 show the state that boundaries of adjacent layers are rotationally shifted so as to be staggered from each other when the second layer L2 and the cover layer L3 are completed.

As described above, embodiments of the laminated core according to the present invention may have a laminated structure in which the first layer and the second layer are alternately disposed a predetermined number of times.

Although the preferred embodiments of the present invention have been disclosed for illustrative purposes, it should be understood by those skilled in the art that these embodiments are given by way of illustration only and the present invention is not limited thereto

Therefore, various modifications, variations, and alterations can be made by those skilled in the art without departing from the spirit and scope of the present invention. And the scope of the invention should be limited only by the accompanying claims and equivalents thereof.

### INDUSTRIAL APPLICABILITY

The present invention related to the laminated core, wherein a laminated core having a structure with layers coupled together by embossed protrusions may be manufactured by a progressive process, and the parallelism, perpendicularity, and flatness of the laminated core may be improved.

1. A laminated core comprising:
first layers arranged spaced apart and comprising a plurality of first segments;
first protrusions having embossed shape on the first layers and configured to form a plurality of first fixing columns to couple the first layers in succession; and
at least one second layers provided between the first layers and comprising a plurality of second segments, wherein
the second layers are provided with first holes through which the first fixing columns pass, and
the first protrusions are connected in a row by press fitting in a protruding direction to form the first fixing column.

2. The laminated core according to claim 1, wherein a boundary of the first segments is staggered from a boundary of the second segments.

3. The laminated core according to claim 1, wherein first protrusions formed along a same line, among the first protrusions, are coupled and form the first fixing column, in the way that a convex portion of a trailing protrusion coupled to a concave portion of a leading protrusion by press fitting in the protruding direction.

4-14. (canceled)

15. The laminated core according to claim 2, wherein first protrusions formed along a same line, among the first protrusions, are coupled and form the first fixing column, in the way that a convex portion of a trailing protrusion coupled to a concave portion of a leading protrusion by press fitting in the protruding direction.

16. The laminated core according to claim 1, further comprising:
second protrusions having embossed shape on the second layers and configured to form a plurality of second fixing columns to couple the second layers in succession,
wherein the first layers are provided with second holes through which the second fixing columns pass.

17. The laminated core according to claim 2, further comprising:
second protrusions having embossed shape on the second layers and configured to form a plurality of second fixing columns to couple the second layers in succession,
wherein the first layers are provided with second holes through which the second fixing columns pass.

18. The laminated core according to claim 1, wherein the first segments and the second segments are annularly disposed to form the first layer and the second layer, respectively.

19. The laminated core according to claim 18, wherein the boundary of the first segments is formed at a position shifted from the boundary of the second segments in a circumferential direction.

20. The laminated core according to claim 19, wherein
the boundary of the first segments is formed at a position shifted from the boundary of the second segments by ½ of an arc angle of the first segment, and
the first protrusions include projections formed on each the first segment and spaced apart from each other by ½ of the arc angle of the first segment in a circumferential direction.

21. The laminated core according to claim 20, wherein the first holes include holes formed on each the second segments and spaced apart from each other by ½ of the arc angle of the second segment in the circumferential direction.

22. The laminated core according to claim 19, further comprising:
second protrusions on the second layers, configured to form a plurality of second fixing columns to couple the second layers in succession, wherein
the first layers are provided with second holes through which the second fixing columns pass,
the second protrusions include projections formed on each the second segments and spaced apart from each other by ½ of the arc angle of the second segment in the circumferential direction, and
the second holes include holes formed on each the first segments and spaced apart from each other by ½ of the arc angle of the first segment in the circumferential direction.

23. The laminated core according to claim 2, wherein the first segments and the second segments are annularly disposed to form the first layer and the second layer, respectively.

24. The laminated core according to claim 1, wherein the first layer and the second layer are alternately stacked with at least one layer, a predetermined number of times.

25. The laminated core according to claim 2, wherein the first layer and the second layer are alternately stacked with at least one layer, a predetermined number of times.

26. The laminated core according to claim 1, wherein a height of the first protrusion is greater than a thickness of the second layer.

27. The laminated core according to claim 26, wherein the height of the first protrusion is N times the thickness of the second layer (N being a natural number of 2 or more).

28. The laminated core according to claim 2, wherein a height of the first protrusion is greater than a thickness of the second layer.

29. The laminated core according to claim 1, further comprising at least one cover layer directly or indirectly stacked on a first layer located at an end in the protruding direction of the first protrusion, among the first layers, and configured to prevent the first protrusion from protruding on a surface of the laminated core.

30. The laminated core according to claim 2, further comprising at least one cover layer directly or indirectly stacked on a first layer located at an end in the protruding direction of the first protrusion, among the first layers, and configured to prevent the first protrusion from protruding on a surface of the laminated core.

31. A method for manufacturing a laminated core comprising first layers comprising a plurality of first segments and having embossed first protrusions formed thereon, and second layers comprising a plurality of second segments and having holes into which the first protrusions are inserted, the method comprising:
(a) stacking the first layer and the second layer on a cover layer forming a bottom surface of the laminated core and having finishing holes to which the first protrusions are fixed by fitting, and forming a lower laminate having a structure where the second layer and the cover layer are fixed under the first layer; and
(b) alternately stacking the second layer and the first layer on the lower laminate a predetermined number of times such that a boundary of the first segments and a boundary of the second segments are staggered from each other to form a layer fixing structure with a plurality of fixing columns formed by the first protrusions coupled in a row by press fitting.
